(19) United States
(12) Patent Application Publication
(10) Pub. No.: US 2004/0205014 A1
(43) Pub. Date: Oct. 14, 2004

(54) System for preparing construction project bids

(76) Inventor: Jack Kaltner, Briarcliff, NY (US)

Correspondence Address: FITZPATRICK CELLA HARPER & SCINTO, 30 ROCKEFELLER PLAZA, NEW YORK, NY, 10112, US

(21) Appl. No.: 10/410,405

(22) Filed: Apr. 10, 2003

(51) Int. Cl. G06F 17/60

(52) U.S. Cl. 705/37

(57) ABSTRACT

Construction project bid information is determined by providing a task database containing a number of tasks. Each task includes a required labor amount. A database of labor rate data also is provided. Drawing data for the construction project is received, which includes structures. The structures are mapped to tasks in the task database to form project elements. A construction cost is determined for each project element based at least in part on the required labor amount for the respective mapped task and labor rate data. The construction costs of the project elements are compiled to obtain a total project cost.

### BACKGROUND OF THE INVENTION

1. Field of Invention

The present invention relates generally to the field of construction projects, and more particularly to the accurate and systematic preparation of construction project bids.

2. Related Art

The construction industry has long been hampered by the difficulties inherent in preparing an accurate construction project bid. The lack of a low cost, systematic, and accurate means for preparing bids has led to the routine inflation of bids by the various parties involved in a project to cover costs that are difficult to estimate. In addition, much time and money is wasted in the haphazard bid preparation and revision process, particularly because inaccurate bids tend to result in disputes among the parties involved in a project. Moreover, many projects that might otherwise have been successfully completed may be deemed unfeasible due to overly inflated bids.

The conventional process for preparing a construction project bid is essentially a manual, iterative process that involves a great deal of guesswork. Typically, an architect will develop construction plans and select materials with a customer over a period of months. Engineers, consultants and other experts may be consulted to resolve questions regarding the structural aspects of the construction plans or the construction materials. The results of this planning process are revised and checked several times and compiled in the project specifications and plans. The specifications and plans are disseminated as bid packages to the various bidders, typically contractors and sub-contractors.

The bidders then begin the initial phase of the costly and time consuming process of preparing a project bid. Each bidder usually has a particular method for computing the bid that generally involves the compilation of cost information for the myriad tasks to be performed and the materials to be used. The cost information is usually based on the bidder's prior experience, information obtained from sub-contractors and suppliers, and a high degree of guesswork. Various manual or computerized techniques may be used to compile the cost information, and there is usually no systematic way to exchange information with the suppliers and sub-contractors and other parties involved in the bid preparation. The process may take several days to complete and ties up the highest-level personnel of the bidder, such as the president of the company.

During this phase, the architects field questions from the bidders. The initial bids are then presented to the architect, who may conduct one or more rounds of value engineering of the construction plans to attempt to reduce the project's cost. Revised bid packages are sent out to the bidders, who, in turn, produce revised bids. The architect then selects a contractor from among the bidders. Once the project begins, significant issues may arise due to inaccuracies and ambiguities inherent in the project planning and bidding processes. For example, unexpected costs may arise due to underestimation of the labor hours required to complete certain tasks.

Certain computer-related systems have been proposed to improve the construction bid preparation process. For example, U.S. Pat. No. 6,446,053 (Elliott) relates to a computerized system in which a user inputs initial information regarding a project and then is presented with a series of step-by-step menus from which to manually select materials for the project. Once all of the materials have been manually selected, the project may be transmitted electronically to contractors, who presumably would then prepare construction bids using conventional techniques. Elliott discusses computing labor costs for certain materials as they are selected from the menus. Elliott also discusses inputting a floor plan to estimate architect's fees or to use as a starting point for a remodeling project. However, there is no description of a systematic means for computing the total labor and material costs of a construction project based on a complete project plan, such as a computer-aided design (CAD) data file.

As a further example, U.S. Pat. No. 6,393,410 (Thompson) relates to a system for performing a take-off estimate for a construction project. A take-off estimate is a conventional method of analyzing a construction plan to determine total quantities of materials required for the project. The system then makes the estimate available to potential contractors and builders, who presumably prepare construction bids using conventional techniques. However, there is no description of estimating project labor costs, much less a systematic means for computing the total labor cost of a construction project based on a complete project plan, such as a computer-aided design (CAD) data file.

In view of the shortcomings discussed above, the invention provides a system for preparing a highly accurate construction project bid that is readily accessible to those in the construction industry, easy to use and inexpensive. The system accepts construction project information in standardized formats and automatically and quickly provides complete bidding information.

### SUMMARY OF THE INVENTION

The present invention generally provides a novel system, method, and computer code for determining construction project bid information.

In one aspect of the present invention, a task database is provided that contains a plurality of tasks. Drawing data for the construction project is received, and the drawing data includes lines. One or more lines in the drawing data are identified as walls. The identified walls are mapped to tasks in the task database to form project elements. A construction cost is determined for each project element based at least in part on an amount of required labor for the respective mapped task and labor rate data. The amount of required labor for a task may be determined by observing actual performance of the task.

Embodiments of this aspect may include one or more of the following features. The determined construction cost for each project element may be based at least in part on an amount of required material for the respective mapped task and material cost data. The construction cost of each project element may be compiled to determine a construction project bid.

The drawing data may include symbols, which may be mapped to tasks in the task database to form project elements. The construction cost of these project elements may be compiled to determine a construction project bid. The drawing data may include output from computer-aided design software.

A server may be used to serve an Internet web page to a user to initiate receipt of the drawing data. The server may serve an Internet web page presenting results of a construction bid determination for the received drawing data. The server may serve an Internet web page for editing the task database.

In another aspect of the present invention, a task database is provided that contains a plurality of tasks, each task including a required labor amount. A database of labor rate data is provided. Drawing data for the construction project is received. The drawing data includes structures such as lines, symbols, objects, and other entities that represent physical structures in the completed project. The structures are mapped to tasks in the task database to form project elements. A construction cost is determined for each project element based at least in part on the required labor amount for the respective mapped task and labor rate data. The construction costs of the project elements are compiled to obtain a total cost.

Embodiments of this aspect, may include the following feature. The determined construction cost for each project element may be based at least in part on an amount of required material for the respective mapped task and material cost data.

In another aspect of the present invention, a server is configured to receive drawing data via the Internet. A task database, which is accessible by the server, contains a plurality of tasks. Each task requires an amount of labor and an amount of material. A labor cost database, which is accessible by the server, contains labor rate data. A material cost database, which is accessible by the server, contains material cost data. A mapping module is configured to map the drawing data to tasks in the task database to form project elements. Each project element has a construction cost based on the amount of required labor, the labor rate data, the amount of required material, and the material cost data. A compiling module is configured to compile the project elements to determine a total project cost.

These and other objects, features and advantages will be apparent from the following description of the preferred embodiments of the present invention.

### BRIEF DESCRIPTION OF THE DRAWINGS

The present invention will be more readily understood from a detailed description of the preferred embodiments taken in conjunction with the following figures.

FIG. 1 is an architectural drawing of a construction project for which a construction project bid is to be prepared in accordance with the present invention.

FIG. 2 is a block diagram of the process for determining a construction project bid.

FIG. 3 is block diagram of a local area network (LAN) configured to receive architectural drawings and prepare construction project bids.

FIG. 4 is a block diagram showing users accessing the system.

FIG. 5 is a block diagram of the logical structure of a construction task database that is divided into sub-projects.

FIG. 6 is a block diagram of the logical structure of a lower level of the construction task database showing tasks and sub-tasks.

FIG. 7 is a Computer-aided Design generated architectural drawing of a project showing the mapping of interior and exterior walls.

FIG. 8 is a Computer-aided Design generated architectural drawing of a project showing the mapping of fixtures.

FIG. 9 is a Web site page for welcoming new and existing clients and allowing registration and log-in.

FIG. 10 is a Web site page for viewing the results of project bid preparation and submit architectural drawings for analysis.

FIG. 11 is a Web site page for viewing the details of a project bid.

FIG. 12 is a Web site page for managing tasks and sub-tasks in the construction task database.

FIG. 13 is a Web site page for managing labor, material, and resource cost databases.

### DESCRIPTION OF THE PREFERRED EMBODIMENT

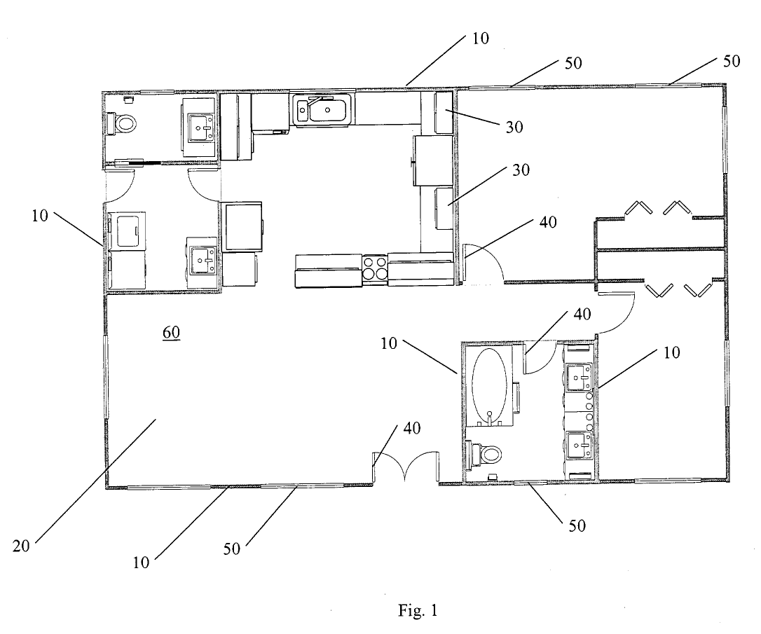

Any given construction project may be documented as a set of construction plans that includes detailed architectural drawings generated by a computer-aided drafting (CAD) package. A well known example of such a package is for example AutoCad™. An example of an architectural drawing generated with a CAD package is illustrated in FIG. 1. The drawing includes details for the fundamental structural elements, such as walls 10, floors 20, and roof, as well as the fixtures to be installed, such as electrical fixtures, cabinets 30, doors 40, windows 50, flooring 60, etc. The present invention provides a method and system that analyzes construction plans using a database of construction cost data to compute a highly accurate construction project bid.

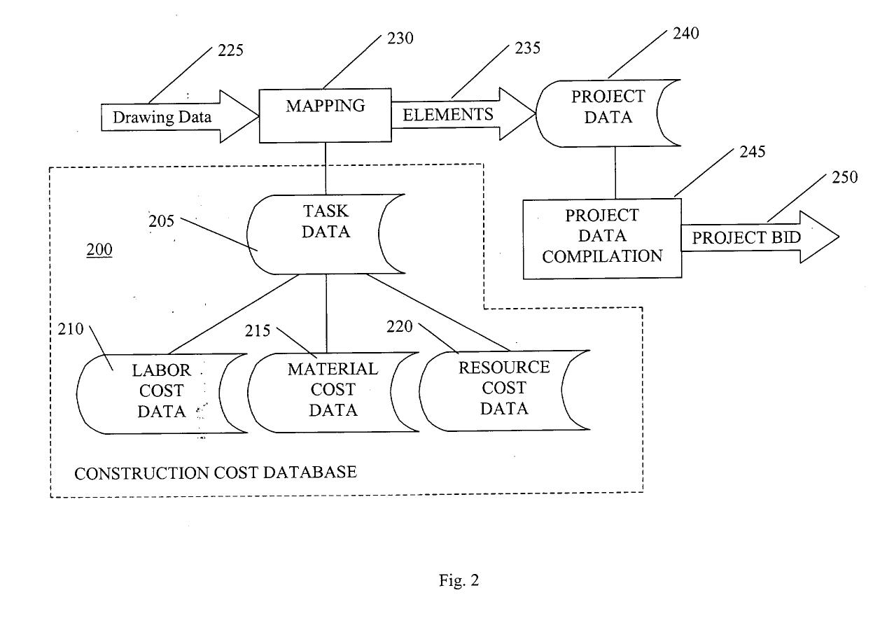

As shown in FIG. 2, a construction cost database 200 includes a task database 205 and labor cost 210, material cost 215, and resource cost databases 220. These components may be implemented in a single database or as separate relational databases. As further described below, the task database 205 contains definitions of the various tasks that are performed in a construction project, such as for example building walls, installing doors and windows, and installing electrical outlets. Each task definition includes the amount of labor, materials, and resources required to complete the task. The costs of these components are determined based on data stored in the labor 210, material 215, and resource databases 220.

Labor is specified for each task in the task database 205 in terms of the labor hours required to complete the task and the types of labor category that are required, e.g., framer, painter, drywall installer, etc. Materials are specified in terms of the quantity of material required to complete the task, such as feet of gypsum wallboard, pounds of nails, feet of 2×4 lumber, etc. Resources, which are certain types of equipment required to complete a task, are specified in terms of the time that the equipment must be used to complete the task, e.g., the number of hours that a crane must be used. The cost of the specified quantities of labor, materials, and resources for each task is determined based on cost data in the labor 210, material 215, and resource 220 databases.

Drawing data 225 for the project, such as the output of a CAD program, is mapped by a mapping module or processor 230 to the tasks in the construction cost database 200, as described below, to generate project elements 235. Each element 235 corresponds to a particular instance of a task to be completed in the project, e.g., the building of a particular wall 10 or installation of a particular door 40, and the cost of that particular task. The elements 235 are stored in a project database 240 and are compiled by a compilation module or processor 245 to determine the project bid 250.

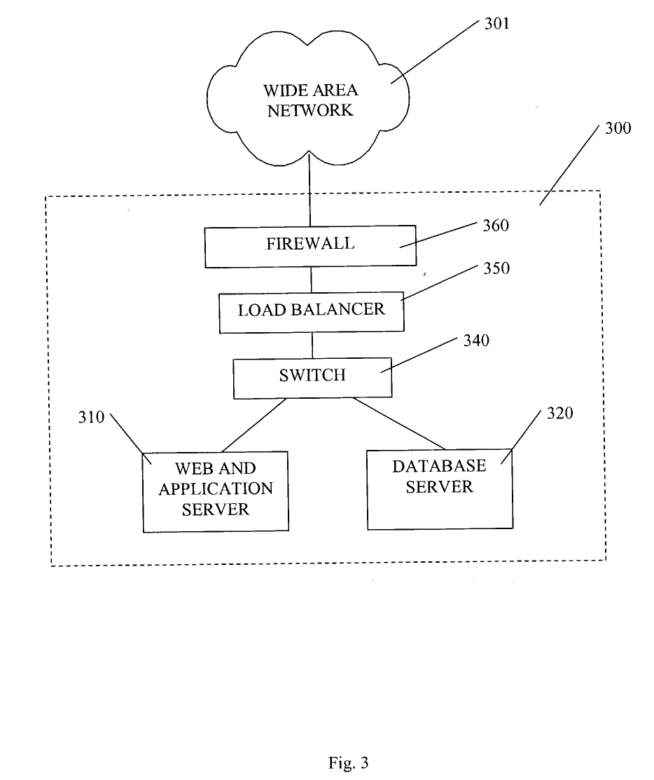

As shown in FIG. 3, the construction project bid preparation system of the present invention may be implemented as a local area network (LAN) 300 that includes a pair of network servers 310 and 320 connected to a wide area network (WAN) 301 through a series of network components 340, 350 and 360. In one embodiment of the present invention, the WAN is the Internet. In any event, one of the network servers may be configured as an application server 310 to run application software that performs the functions associated with receiving construction plans and generating construction bid results, as well as various administrative functions. The application server 310 may also be configured as a Web server 310 to run software that provides a Web site interface for clients and administrative users. Alternatively, a separate server may be used to host the Web site. The other network server may be used as a database server 320 to maintain a database of construction cost information 200 and other associated databases. These servers 310 and 320 may be connected to the WAN 330, e.g., the Internet, through a switch 340 and load balancer 350, and a firewall 360. More complex network configurations may be employed, as necessary, depending upon system requirements. For example, a separate server may be provided to act as the Web server.

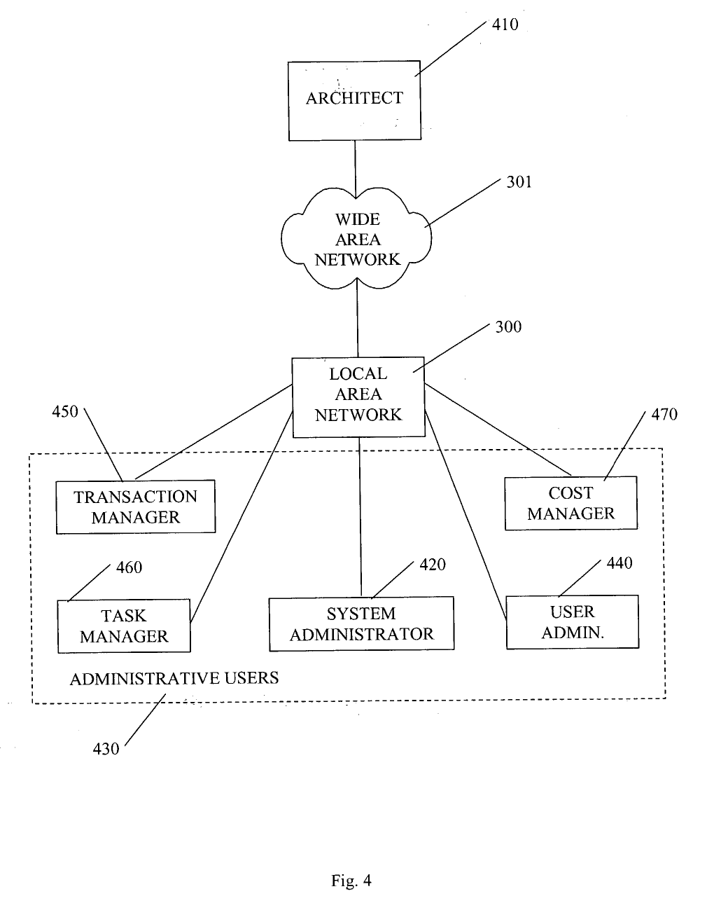

As shown in FIG. 4, the LAN 300 may be accessed by a number of different types of users, each of which has a particular role in the overall system. The client 410 submits construction plans to the system and receives the resulting construction bid output. The client 410 may be, for example, an architect, contractor, project owner, or any other party involved in a construction project who is in need of accurate construction cost information. The client is generically referred to herein as the architect 410. The plans may be submitted electronically via an Internet Web site provided by the LAN 300 or by any other electronic means, such as email or a direct modem connection. The plans also may be submitted by alternative means, such as by mailing the plans on a compact disc to be directly loaded into a computer in the LAN 300 or by sending a set of printed architectural drawings to be scanned and converted into digital data. Each architect 410 maintains an account on the system, so that they can monitor each submission and the resulting output, which is referred to as a transaction.

The System Administrator 420, which is one of the administrative users 430, is responsible for monitoring, controlling, and maintaining the operation of the LAN 300. These responsibilities include maintaining the operation of the network hardware and carrying out top-level control of the software, such as determining all operational parameters and settings. For example, the System Administrator 420 sets up and controls the capabilities of all other users, although this responsibility may be delegated to a separate User Administrator 440. The System Administrator 420 may access the LAN 300 directly, e.g., through a computer that is directly connected to the LAN 300 or may access the LAN 300 through an Internet Web site. In the latter case, the Web site would provide security mechanisms to ensure that only the System Administrator 420 would have access to the control portions of the LAN 300 software.

The Transaction Manager 450, Task Manager 460, and Cost Manager 470 are administrative users that may be implemented as separate users or combined into the responsibilities of the System Administrator 420, based on business considerations. The Transaction Manager 450 is responsible for monitoring and controlling the transactions run by the system, which includes the submission of construction plans, payment by the architect, and output of the construction bid results. The Transaction Manager 450 can review, print, sort, and delete transactions and is responsible for assisting the architect 410 with any questions or problems associated with a transaction. The Task Manager 460 creates and maintains the task database 205 (see FIG. 2), which are defined series of construction steps required to achieve a particular aspect of the construction plan, for example, demolishing a wall, installing an electrical outlet, installing a window, etc. The Cost Manager 470 creates and maintains the databases of labor 210, material 215, and resource costs 220 that are the constituents of each construction task. As with the System Administrator 420, these other administrative users 430 may also access the LAN 300 directly or through an Internet Web site.

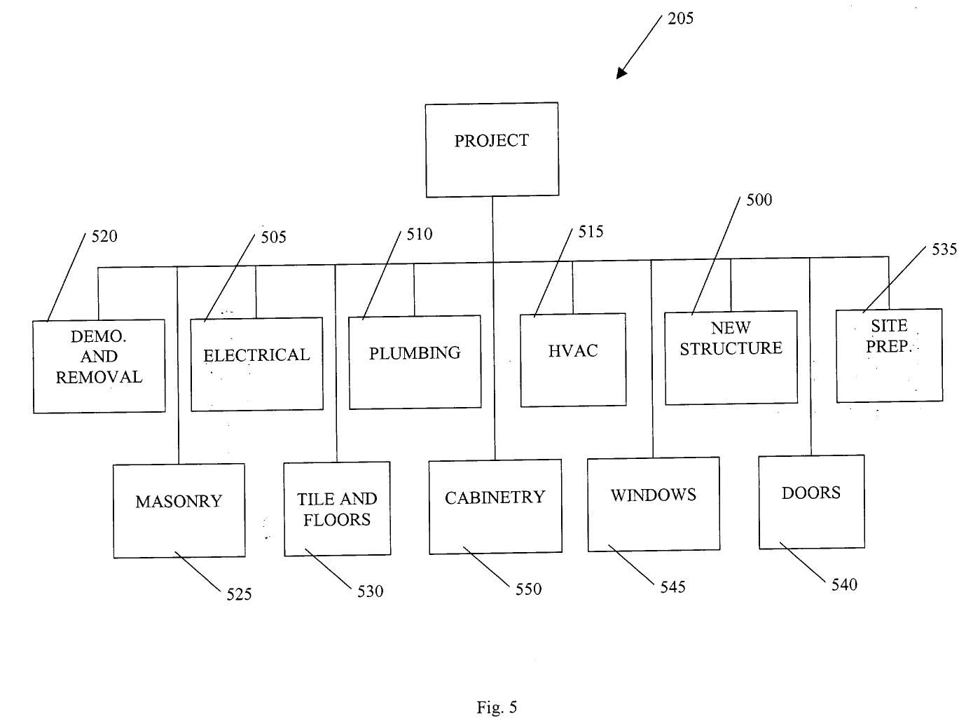

As shown in FIG. 5, the task database 205 is logically organized according to the structure of a typical construction project. The task database 205 is divided into sub-projects, each of which corresponds to a particular construction discipline, such as electrical 505, plumbing 510, and heating, ventilation and air-conditioning (HVAC) 515. Sub-projects are also defined for areas of construction specialty, such as new structures 500, demolition 520, masonry 525, tile and flooring 530, site preparation 535, doors 540, windows 545, cabinetry 550, etc. The task database may have a sub-project field that categorizes the records according to sub-project, or the task information for each sub-project may be stored in a separate relational database.

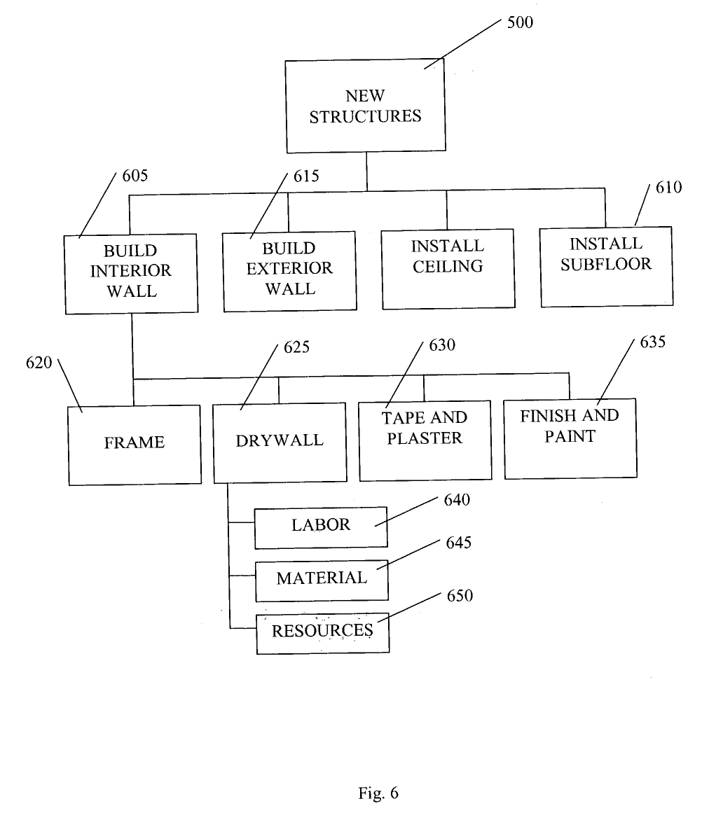

As shown in FIG. 6, each sub-project has a number of constituent tasks and sub-tasks that define steps that are to be performed. For example, the New Structures 500 sub-project encompasses tasks such as building interior walls 605, installing sub-floors 610, building exterior walls 615, etc. Each of these tasks may have a number of associated subtasks. For example, the task of building an interior wall 605 includes the sub-tasks of framing 620, hanging drywall 625, taping and plastering 630, and painting 635. Each of these sub-tasks may include lower level sub-tasks. Each task or sub-task requires a certain amount of labor 640, material 645, and resources 650, and the cost of these components is computed based data in the labor 210, material 215, and resource 220 cost databases (see FIG. 2).

The Labor costs of a particular task depend on the amount of required labor 640, which is the number and type (i.e., labor category) of workers and the labor hours required to complete the task, and the corresponding labor rates. Each type of worker has a corresponding hourly labor rate, which is based on an average rate for a particular region. Thus, the labor cost database 210 (see FIG. 2) is customized to a particular region. The total labor cost for a task is the sum of the cost for each laborer, which is the labor rate for that worker times the number of labor hours required. For example, installing drywall may require two drywall installers at $20 per hour (per installer) and may require 5 minutes of labor per foot of drywall. Installing 12 feet of drywall would therefore entail a labor cost of $40.

The labor hours required for a particular task can be determined in a number of ways. One source of such information is practical on-the-job experience by the administrative personnel. Another source is planned studies of on-site activities, either first-hand or by automated monitoring. For example, a site supervisor may monitor the installation of drywall over the course of a day in order to compute the labor hours required for that sub-task. The supervisor would ensure that the installation is done efficiently during the study, so that the determined labor costs can serve as a benchmark for efficient construction methods. Thus, the construction project bid computed based on these labor costs is not only accurate, but also may be used to hold contractors to a high standard of efficiency.

Material costs depend on the amount of required material 645 for a task and the cost of the material per unit amount in the particular region in question, which is stored in the material cost database 215. For example, drywall may cost $5/ft., so installing 12 ft. of drywall would entail a material cost of $60. The system automatically applies volume discounts based on the total material quantities for the project when appropriate.

Resources are reusable equipment needed for a task, such as a crane, backhoe, etc. The resource costs for a task depend on the amount of required resources 650 for the task and the cost of the resource, which is stored in the resource database 220. For example, if a crane cost $250/hour and were needed for 2 hours for a particular task, the resource cost for that task would be $500. The resource costs also depend on the region in which the project is located. In an alternative embodiment, the costs of reusable equipment may be stored along with materials in the material cost database 215, rather than in a separate resource database 220.

Referring again to FIG. 2, the drawing data 225 for the construction project under analysis is mapped to task data 200 to determine the construction project bid 250. The drawing data may be data output by CAD software and may be divided into layers or other types of logical divisions corresponding to the various aspects of a project, such as electrical, plumbing, HVAC, and demolition. The system maps each layer to a corresponding sub-project of the task database. This mapping is done automatically using layer identification data in the CAD file. The use of such layer identifiers may be based on industry practice, such as for example the guidelines adopted by the American Institute of Architects (CAD Layer Guidelines: Computer-aided Design Management Techniques for Architecture, Engineering, and Facility Management, ed. Michael K. Schley, Second Edition, The American Institute of Architects Press, 1997). Alternatively, the layer identifiers may be based on a set of predetermined layer names that is distributed to clients. For example, the system Web site may provide specifications for identifying layers, and the architect can draft the drawings using these specifications or modify the drawings to meet these specifications before submitting them.

If a layer cannot be automatically mapped, the system prompts the architect to complete the mapping between the CAD file and the internal logical divisions used by the system. For example, if the architect uses a layer name that cannot be recognized as one of the predefined layer names (i.e., electrical, plumbing, etc.), then the architect is prompted to map the unrecognized layer to one of the predefined layers. Alternatively, the drawings may be flagged for attention by the system, and the Transaction Manager may manually map unrecognized layers with the predefined layers.

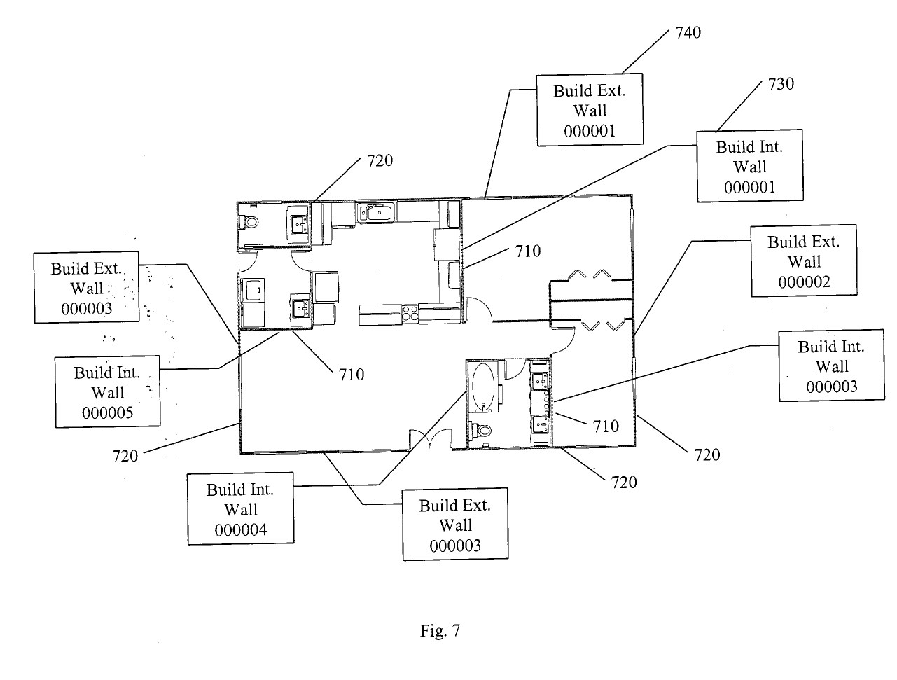

Once the layer mapping has been completed, each layer is analyzed to map each specific structure of the layer to a corresponding task or sub-task in the corresponding sub-project of the task database. For example, as shown in FIG. 7, a layer of the architectural drawings may contain lines or groups of lines that represent interior 710 and exterior 720 walls to be constructed or walls to be demolished. Each line 710 and 720 has a corresponding entry in the CAD data that provides the coordinates of the line and other characteristics, such as line thickness. The system identifies the walls using predetermined criteria that are based on industry practice for depicting walls in CAD drawings. The criteria may include, for example, line type, length, thickness, and the distance between closely spaced parallel lines.

In addition to the identification criteria described above, there may also be identifiers embedded in the CAD data that identify the lines as walls and indicate whether the walls are internal or external or to be demolished. These identifiers may include tags, flags, labels, or any other data structure that logically categorizes the lines. In addition, the walls may be provided on a predetermined layer of the CAD drawing, such as a New Structures layer, that implicitly identifies the structure as a wall to be constructed. The use of such identifiers or layers may be based on industry practice, as discussed above, or may be specified to the architect prior to drafting. For example, the system Web site may provide specifications for identifying walls in CAD drawings, and the architect can draft the drawings using these specifications or modify the drawings to meet these specifications before submitting them.

As discussed above, the system discriminates whether a wall is internal or external based on the certain predetermined criteria, the layers on which the lines are stored, and/or embedded identifiers. The system may also discriminate whether a wall is internal or external based on the relative position of the lines in the drawing. In such a case, walls forming a perimeter around the drawing (e.g., 720) would be identified as external, while walls positioned within this perimeter (e.g., 710) would be identified as internal.

Referring again to FIG. 7, once the walls have been identified, the system performs a mapping between the walls and the corresponding tasks or sub-tasks required to construct the walls. For example, interior walls 710 are mapped to the Build Interior Wall task 730, exterior walls 720 are mapped to the Build Exterior Wall task 740, and walls to be demolished are mapped to the Demolish Wall task. Each wall is mapped to an individual occurrence of the corresponding task, which is referred to as a project element. Each element is uniquely identified, for example by a number. The elements are added to a project database for the construction project being analyzed.

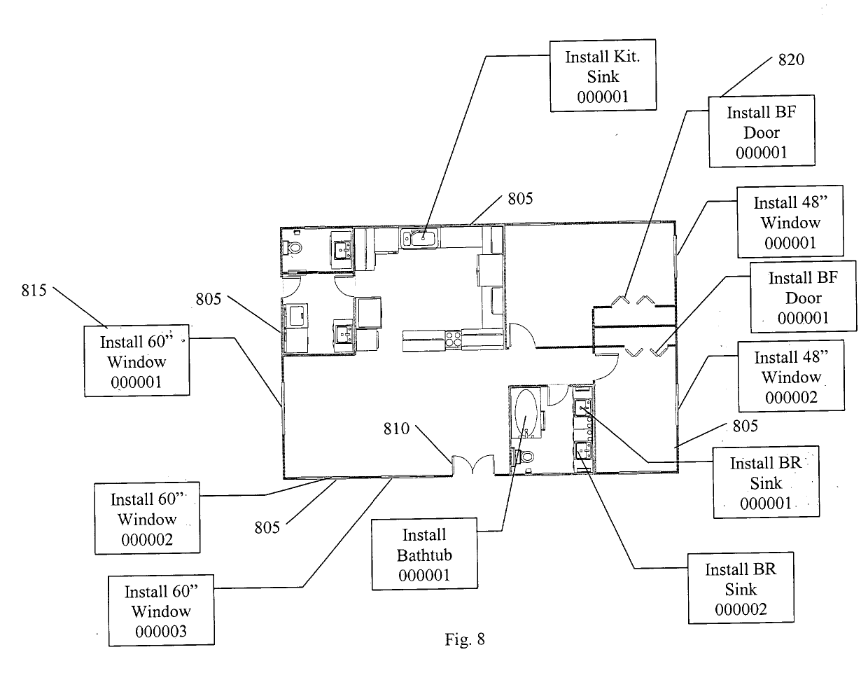

As shown in FIG. 8, the drawings also contain symbols, objects, or other entities (referred to collectively as symbols herein) that represent fixtures such as windows 805, doors 810, electrical outlets, etc. The system performs a mapping between each of these symbols and an individual occurrence of the corresponding task or sub-task, e.g., install window 815, install door 820, install electrical outlet, by referring to an internal symbol database. Each mapping results in a uniquely identified project element, which is added to the project database. The CAD data may contain manufacturer and part number information for a fixture. In such a case, the system will search the material cost database to retrieve price information for the particular part in question. The system may retrieve updated price information from a manufacturer's Web site via the Internet. If the CAD data does not include such specific information, a generic estimate of the cost of the fixture may be used. The price of the fixture is then added to the fixture installation element as a material cost.

If a symbol is not recognized by the system, because it does not exist in the internal symbol database, then the architect is prompted to manually map the symbol to a corresponding task. Alternatively, the drawings may be flagged for attention by the system, and the Transaction Manager may manually map the unrecognized symbol with a corresponding task. There may also be a provision for adding unrecognized symbols to the internal database of symbols.

This mapping process continues until all of the structures and symbols on all of the layers of the drawings have been mapped and corresponding elements have been added to the project database. The labor, material, and resource costs for all of the elements are summed to determine a total project cost. As further discussed below, the cost information may be presented in summarized form according to sub-project or other categories or as a detailed listing of individual items.

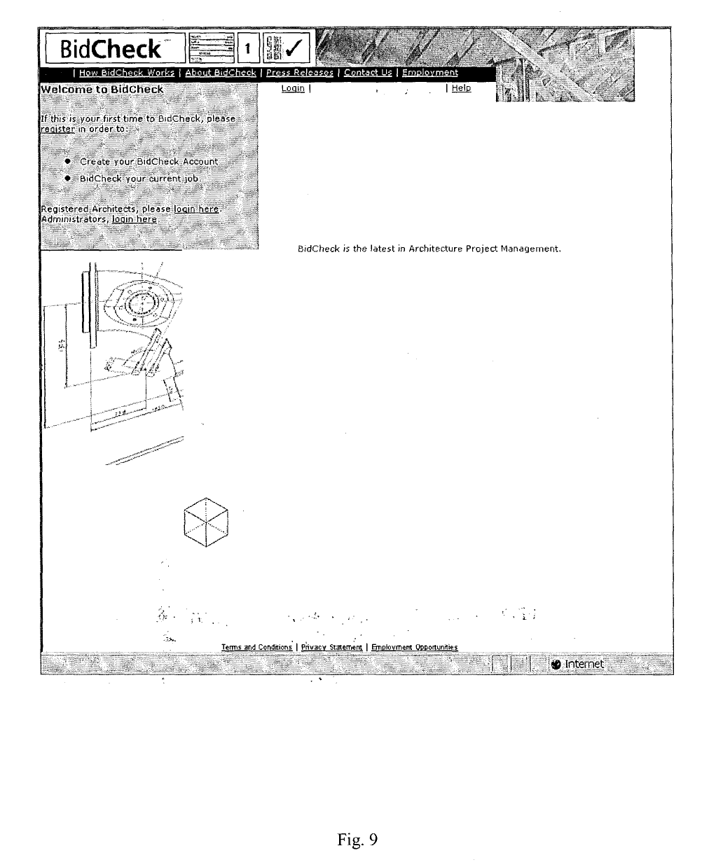

An Internet Web site may be used to provide an interface to allow both architects and administrative personnel to access the system. As shown in FIG. 9, the system Web site provides a home page to welcome clients and potential clients. The home page allows architects to register or to log-in to an existing account. It also provides information on the system and links to additional information and assistance. A similar home page may be presented to administrative personnel.

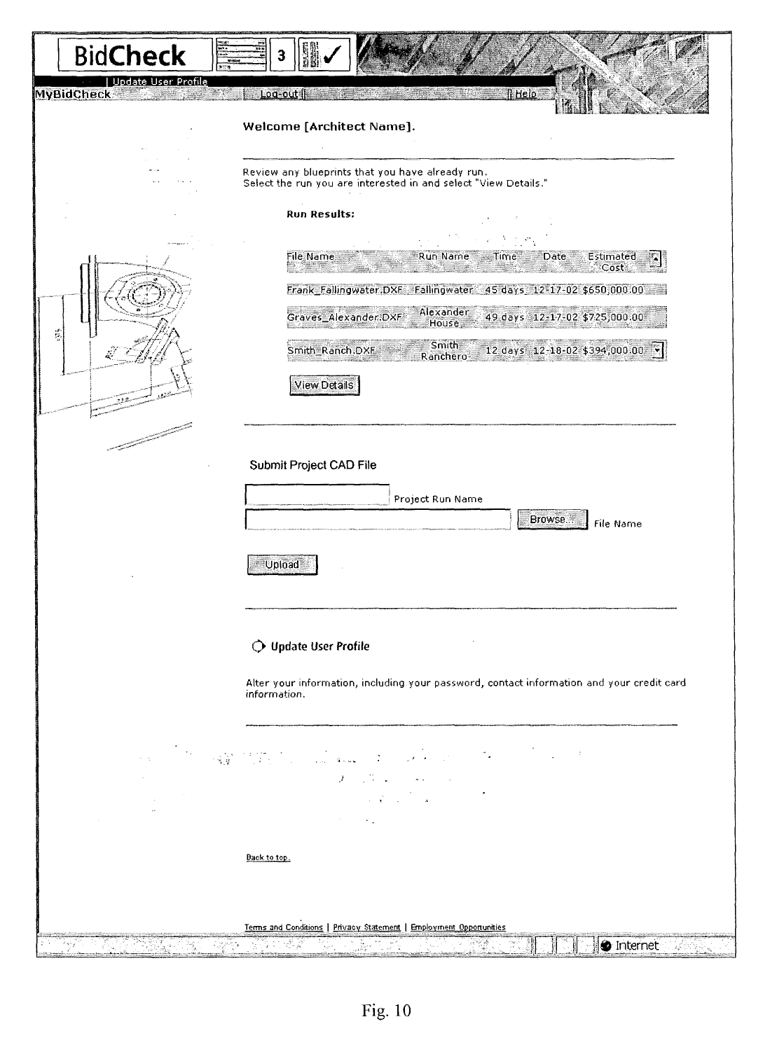

After log-in, the architect is presented with the “My BidCheck” page, as shown in FIG. 10, which provides information regarding the architect's account and projects that were previously submitted for analysis. The page provides a summary of recently run analyses and their results and provides a link to further details. The page allows the architect to submit a CAD file for analysis by uploading it to the Web site. In addition, the page allows the architect to update information in the personal profile associated with the account.

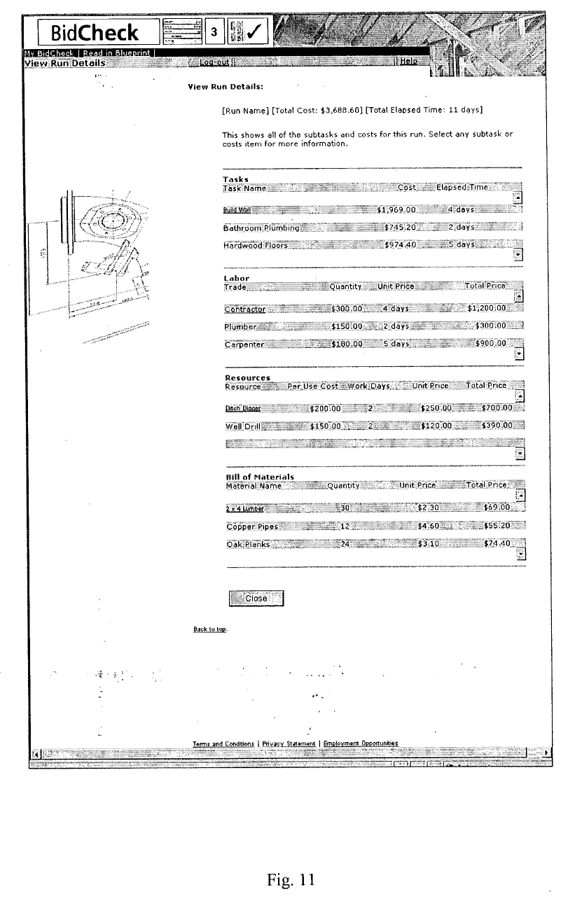

As shown in FIG. 11, the “View Run Details” page presents a summary of the results of a construction project analysis. At the top of the page is a summary of the total cost and estimated time for the project. The remainder of the page is divided into four sections. The first section summarizes the cost and estimated time for all of the tasks and subtasks that are to be preformed for the project. The architect may select a task to view further detail, such as the labor, material and resource costs for the selected task. The remaining sections summarize the total labor, material, and resource costs for the project, and the architect may select a particular labor category or type of material or resource to view further detail for the selected item.

Other pages of the Web site allow the details of each cost category to be printed out. For example, a Bill of Materials can be printed that provides the cost and quantity of all of the materials for the project, and a Labor List can be printed that provides the cost and number of labor hours for each labor position required for the project.

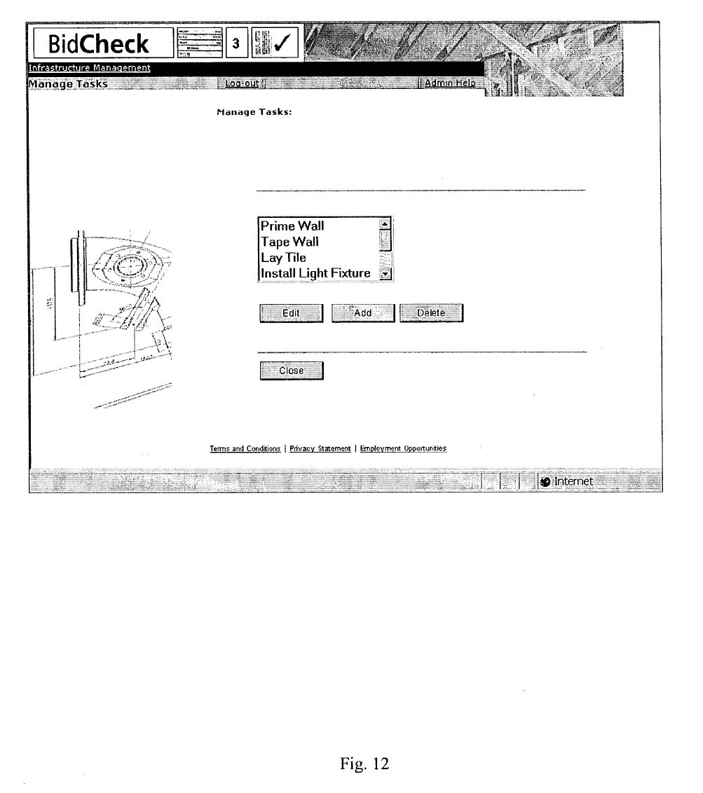

Administrative personnel can access administrative pages, which are not available to clients, that allow modification of the task database and other aspects of the system. FIG. 12 shows an example of a “Manage Tasks” page that allows the Task Manager to add, edit, and delete task and sub-task definitions in the task database. For example, the Task Manager may wish to edit the number of labor hours under the Drywall task to reflect a more accurate estimate of the required labor hours based on studies of actual performance on the job site.

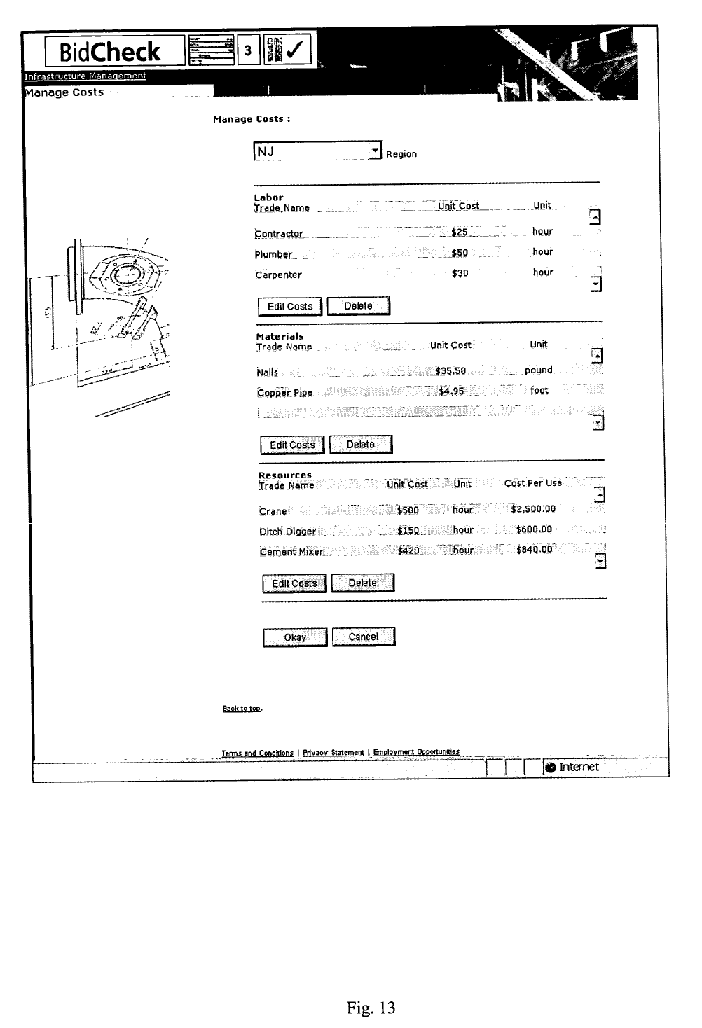

As shown in FIG. 13, similar pages allow administrative personnel to modify the labor, material, and resource costs, which, as discussed above, may be stored in separate relational databases. For example, modifying the cost of gypsum wallboard in the material cost database would be reflected in the material cost of the Drywall sub-task of the Build Internal Wall task and in any other tasks and sub-tasks that use that material. Likewise, a change in the labor rate for a particular type of laborer, e.g., the hourly rate for a framer, would be reflected in any task or sub-task requiring that labor category. In this way, accurate labor, material, and resource cost information can easily be applied to the entire task database. Moreover, it may be possible to use a single task database for several regions, as only the labor, material, and resource cost databases would need to be specific to a particular region.

It will be appreciated that because the system provides an automated process for preparing an accurate construction bid, it will allow the construction industry to eliminate inefficiencies in the contracting process. For example, it will substantially reduce the amount of time that experienced personnel, such as general contractors, will be required to spend preparing construction bids. It will also substantially reduce inflation of construction bids to account for uncertainties in the manual bid preparation process. It will also be appreciated that because the cost and labor hour information provided by the system is objective and based on reasonable costs and efficient construction techniques, the bids prepared by the system can serve as a benchmark against which the efficiency of a contractor can be measured.

In addition, it will be appreciated that because all of the tasks in the task database use common labor, material, and resource cost databases, cost information can be updated easily and efficiently and the results will be propagated throughout the entire task database. It will be appreciated that because the system provides a database that is particularized to the region in which a project is being built, a highly accurate construction project bid can be prepared.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed is:

1. A method for determining construction project bid information, comprising the steps of:
providing a task database containing a plurality of tasks, each task including a required labor amount;
providing a database of labor rate data;
receiving drawing data for the construction project, the drawing data including structures;
mapping the structures to tasks in the task database to form project elements;
determining a construction cost for each project element based at least in part on the required labor amount for the respective mapped task and labor rate data; and
compiling the construction costs of the project elements to obtain a total cost.

2. The method of claim 1, wherein the determined construction cost for each project element is based at least in part on an amount of required material for the respective mapped task and material cost data.

3. A method for determining construction project bid information, comprising the steps of:
providing a task database containing a plurality of tasks;
receiving drawing data for the construction project, the drawing data including lines;
identifying one or more lines in the drawing data as walls;
mapping the identified walls to tasks in the task database to form project elements; and
determining a construction cost for each project element based at least in part on an amount of required labor for the respective mapped task and labor rate data.

4. The method of claim 3, wherein the determined construction cost for each project element is based at least in part on an amount of required material for the respective mapped task and material cost data.

5. The method of claim 4, further comprising the step of compiling the construction cost of each project element to determine a construction project bid.

6. The method of claim 3, wherein the drawing data includes symbols, the method further comprising the step of mapping the symbols to tasks in the task database to form project elements.

7. The method of claim 6, further comprising the step of compiling the construction cost of each project element to determine a construction project bid.

8. The method of claim 3, wherein the drawing data comprises output from computer-aided design software.

9. The method of claim 3, wherein in said receiving step, a server serves an Internet web page to a user to initiate receipt of the drawing data.

10. The method of claim 3, wherein a server serves an Internet web page presenting results of a construction bid determination for the received drawing data.

11. The method of claim 3, wherein a server serves an Internet web page for editing the task database.

12. The method of claim 3, further comprising the step of determining the amount of required labor for a task in the task database by observing actual performance of the task.

13. A system for determining construction project bid information, comprising:
a task database containing a plurality of tasks;
means for receiving drawing data for the construction project, the drawing data including lines;
means for identifying one or more lines in the drawing data as walls;
means for mapping the identified walls to tasks in the task database to form project elements; and
means for determining a construction cost for each project element based at least in part on an amount of required labor for the respective mapped task and labor rate data.

14. The system of claim 13, wherein the determined construction cost for each project element is based at least in part on an amount of required material for the respective mapped task and material cost data.

15. The system of claim 14, further comprising means for compiling the construction cost of each project element to determine a construction project bid.

16. The system of claim 13, wherein the drawing data includes symbols, the system further comprising means for mapping the symbols to tasks in the task database to form project elements.

17. The system of claim 16, further comprising means for compiling the construction cost of each project element to determine a construction project bid.

18. A system for preparing a construction bid, comprising:
a server configured to receive drawing data via the Internet;
a task database accessible by the server and containing a plurality of tasks, each task requiring an amount of labor and an amount of material;
a labor cost database accessible by the server and containing labor rate data;
a material cost database accessible by the server and containing material cost data;
a mapping module configured to map the drawing data to tasks in the task database to form project elements, each project element having a construction cost based on the amount of required labor, the labor rate data, the amount of required material, and the material cost data; and
a compiling module configured to compile the project elements to determine a total project cost.

19. Computer code for determining construction project bid information, the computer code comprising:
code for providing a task database containing a plurality of tasks;
code for receiving drawing data for the construction project, the drawing data including lines;
code for identifying one or more lines in the drawing data as walls;
code for mapping the identified walls to tasks in the task database to form project elements; and
code for determining a construction cost for each project element based at least in part on an amount of required labor for the respective mapped task and labor rate data.

20. The computer code of claim 19, wherein the determined construction cost for each project element is based at least in part on an amount of required material for the respective mapped task and material cost data.

21. The computer code of claim 20, further comprising code for compiling the construction cost of each project element to determine a construction project bid.

22. The computer code of claim 19, wherein the drawing data includes symbols, the computer code further comprising code for mapping the symbols to tasks in the task database to form project elements.

23. The computer code of claim 22, further comprising code for compiling the construction cost of each project element to determine a construction project bid.

24. The computer code of claim 19, wherein the drawing data comprises output from computer-aided design software.

25. The computer code of claim 19, wherein said code for receiving drawing data includes code for serving an Internet web page to a user to initiate receipt of the drawing data.

26. The computer code of claim 19, further comprising code for serving an Internet web page presenting results of a construction bid determination for the received drawing data.

27. The method of claim 19, further comprising code for serving an Internet web page for editing the task database.

28. Computer code for determining construction project bid information, the computer code comprising:
code for providing a task database containing a plurality of tasks, each task including a required labor amount;
code for providing a database of labor rate data;
code for receiving drawing data for the construction project, the drawing data including structures;
code for mapping the structures to tasks in the task database to form project elements;
code for determining a construction cost for each project element based at least in part on the required labor amount for the respective mapped task and labor rate data; and
code for compiling the construction costs of the project elements to obtain a total cost.

29. The computer code of claim 28, wherein the determined construction cost for each project element is based at least in part on an amount of required material for the respective mapped task and material cost data.
